(19) United States
(12) Patent Application Publication
(10) Pub. No.: US 2009/0192874 A1
(43) Pub. Date: Jul. 30, 2009

(54) SYSTEMS AND METHODS FOR TARGETED ADVERTISING

(76) Inventors: Benjamin John Powles, Belmont (NZ); Abbas Bigdeli, Queensland (AU); Hossein Sarrafzadeh, Albany (NZ)

Correspondence Address: LAW OFFICE OF JAMES TROSINO, P.O. BOX 200, YONKERS, NY, 10703, US

(21) Appl. No.: 12/295,765

(22) PCT Filed: Apr. 3, 2007
(86) PCT No.: PCT/NZ07/00070

§ 371 Date: Oct. 2, 2008

(30) Foreign Application Priority Data
Apr. 4, 2006 (NZ) 546390

(51) Int. Cl. G06Q 30/00; G06Q 99/00; H04N 5/225; G06K 9/62

(52) U.S. Cl. 705/10; 705/14; 348/207.1; 382/224; 348/E05.048

(57) ABSTRACT

A system and method for providing advertising media to consumers is described. The system comprising image capture means, an image processing unit connected to the image capture means. In use, the image processing unit executing one or more pattern recognition algorithms on an image received from the image capture means to extract information from the image relating to consumers in the image. The system compiling a list of attributes associated with an individual consumer based on the extracted information. The system including an advertising media database, an advertising selection unit connected to the image processing unit and the advertising media database. In use the advertising selection unit selecting advertising media from the advertising media database based on the list of attributes. The system also including an advertising delivery unit connected to the advertising selection unit for delivering advertising media selected by the advertising selection unit.

### FIELD OF THE INVENTION

The present invention relates to providing targeted advertising to consumers. In particular, the invention relates to providing targeted advertising based on information extracted from images of consumers.

### BACKGROUND TO THE INVENTION

Advertising is everywhere. Companies are spending more on advertising for products than ever before, on an ever expanding range of media. As a result, consumers are becoming more advertising savvy and are becoming (both consciously and subconsciously) more adept at tuning out or ignoring advertising.

For advertisers this means that it is increasingly difficult to make advertisements stand out and be noticed. Furthermore, to reach a mass audience and be noticed, an advertiser must advertise using multiple media and advertise frequently, as well as having good quality advertising material. At the same time, advertisers are, and will continue to be, demanding of advertisements to produce measurable results and provide a quantifiable return on investments.

The impact of advertising can be considerably increased if the advertising is targeted to the audience receiving it. Advertising campaigns are generally conceived with a target audience in mind. If the advertising can effectively reach that target audience, without having to pay for exposure to the rest of the world as well, then considerable cost can be saved.

There have been a number of prior systems that provide targeted advertising to an audience. Many of these relate to advertising on the Internet, using content analysis to target individuals. Other targeted advertising systems exist which are intended for interactive television audiences and for mobile telephones.

Some prior systems provide targeted advertising using visual recognition techniques. One such system is disclosed in US2005/0149398. This system is for use in a retail environment. The system uniquely identifies individuals using image recognition software and/or transaction details. The individual's details are stored in a database and these details are used to select appropriate advertising for display in the vicinity of the individual. In order to be effective this system therefore requires the building and maintenance of a large database of individual images and associated individual details.

US 2005/0018216 uses visual recognition software to analyse customers' personal photographs in a printing kiosk. Information extracted from the photographs is used to select appropriate advertisements for display.

U.S. Pat. No. 6,873,710 discloses a system for tuning the content of information displayed to an audience based on information extracted from audio or visual information about that audience. Extracted information includes statistical information on audience attentiveness, the age profile, race profile, and gender profile of the audience and the rate of change of the audience.

However, none of the prior systems for targeted advertising are able to extract information from video images of customers in real-time, ascribe that information to individual customers and use it to target advertising to an individual.

The term “comprising” as used in this specification means “consisting at least in part of”. When interpreting each statement in this specification that includes the term “comprising”, features other than that or those prefaced by the term may also be present.

Related terms such as “comprise” and “comprises” are to be interpreted in the same manner.

As used herein the term “and/or” means “and” or “or”, or both.

As used herein “(s)” following a noun means the plural and/or singular forms of the noun.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

The entire disclosures of all applications, patents and publications, cited above and below, if any, are hereby incorporated by reference.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

It is an objective of the present invention to overcome the abovementioned deficiency or at least to provide the public with a useful choice.

### SUMMARY OF THE INVENTION

According to one aspect of the present invention, a system for providing advertising media to consumers comprises:

image capture means;

an image processing unit connected to the image capture means, in use, the image processing executing one or more pattern recognition algorithms on an image received from the image capture means to extract information from the image relating to consumers in the image, and compiling a list of attributes associated with an individual consumer based on the extracted information;

an advertising media database;

an advertising selection unit connected to the image processing unit and the advertising media database, in use the advertising selection unit selecting advertising media from the advertising media database based on the list of attributes; and

an advertising delivery unit connected to the advertising selection unit for delivering advertising media selected by the advertising selection unit.

Preferably, when the image includes more than one consumer, the image processing unit compiles a list of attributes for each individual consumer in the image. Alternatively, the image processing unit may compile lists of attributes for only some of the individual consumers.

Preferably, the image capture means includes a camera. Preferably, the camera is a digital camera. The image capture means may also include further cameras and sensors. Preferably, the image processing unit comprises one or more microprocessors. Preferably, the advertising selection unit comprises one or more microprocessors. The image processing unit and the advertising selection unit may be integrated in a single hardware device or may be distributed over two or more hardware devices. Preferably, the advertising delivery unit is a display screen.

Preferably, the list of attributes compiled by the image processing unit relates to clothing worn by the consumer. In addition, the list of attributes may include whether the consumer is alone or in a group, whether the consumers in the image include a child, or an estimation of the consumer's age, race, gender, and attire type (i.e. formal or casual)

Preferably, the image capture means and the advertising delivery unit are located proximate to one another. Preferably, the image capture means and the advertising delivery unit are installed in a public place.

Preferably, the advertising delivery unit is a display screen. Alternatively, or in addition, the advertising delivery unit comprises another form of display, a loud speaker, means to emit a scent or means to deliver promotional goods.

Preferably, the advertising selection unit is configured to select advertising media based on the list of attributes and rules stored within the advertising selection unit. Preferably, the system further includes a control unit connected to the advertising selection unit that allows the rules to be amended by a user.

Preferably, the image processing unit executes the one or more pattern recognition algorithms at set time intervals. Preferably, the image processing unit does not execute the one or more pattern recognition algorithms when advertising is being delivered by the advertising delivery unit.

According to a second aspect of the invention, a method for providing targeted advertising to consumers comprises the steps of:

capturing an image of one or more consumers;

executing one or more pattern recognition algorithms on the image to extract information from the image relating to consumers in the image, and compiling a list of attributes associated with an individual consumer based on the extracted information;

selecting advertising media from a store of advertising media files based on the list of attributes; and

delivering advertising media to the consumers selected by the advertising selection unit.

Preferably, the method steps are performed in real-time so as to deliver targeted advertising to the consumer soon after the image has been captured.

Preferably, the method further includes the step of assigning a certainty ranking to each attribute in the list of attributes. Preferably, the step of selecting advertising media based on the list of attributes further includes disregarding all attributes with a certainty ranking below a user set threshold.

Preferably, the step of selecting advertising media includes applying a set of rules to the list of attributes and the media files to determine which advertising media to deliver. Preferably, the method further includes the step of editing the rules. Preferably, the method further includes the step of assigning weighting values to each advertising media file.

Preferably, the step of editing the rules comprises prioritising a type of symbol or characteristic as the basis for selection of an advertising media file.

According to a third aspect of the present invention, a system for providing advertising media to consumers comprises:

image capture means;

an image processing unit connected to the image capture means, in use, the image processing executing one or more pattern recognition algorithms on an image received from the image capture means to extract information from the image relating to non-physiological attributes of the consumers in the image;

an advertising media database;

an advertising selection unit connected to the image processing unit and the advertising media database, in use, the advertising selection unit selecting advertising media from the advertising media database based on the extracted information; and

an advertising delivery unit connected to the advertising selection unit for delivering advertising media selected by the advertising selection unit.

The invention may also be said broadly to consist in the parts, elements and features referred to or indicated in the specification of the application, individually or collectively, and any or all combinations of any two or more of said parts, elements or features. Where specific integers are mentioned herein which have known equivalents in the art to which this invention relates, such known equivalents are deemed to be incorporated herein as if individually set forth.

### BRIEF DESCRIPTION OF THE DRAWINGS

Examples of the present invention will now be described in detail with reference to the accompanying drawings, in which:

FIG. 1 is a schematic diagram showing a system in accordance with the present invention;

FIG. 2 is a flow diagram illustrating a method for providing targeted advertising in accordance with the present invention;

FIG. 3 shows a schematic diagram of an advertising selection unit in accordance with the present invention; and

FIG. 4 shows detail of an administration unit in the advertising selection unit in accordance with the present invention.

### DETAILED DESCRIPTION

The most basic embodiment of the present invention is a system that consists of a television or other display screen capable of showing pictures and/or text connected to a digital camera and a computer processor. In use, the camera scans the environment and the processor analyses images captured by the camera, looking for predetermined symbols or characteristics. When these are found the screen will display an appropriate message or advertisement specifically tailored to or targeting the individual connected with the recognised symbol and/or characteristics.

The system is intended for use in public places such as shopping centres, supermarkets, airports, train stations and streets. The camera is set up to cover an area of consumer traffic and may be installed so as to be conspicuous to consumers or may be substantially hidden from view. The display screen is ideally in the vicinity of the area that the camera collects images from.

The system of the present invention allows advertisers to display specific advertisements to specific consumers (or groups of consumers), based on assumptions made about those consumers, derived from symbols or characteristics associated with those consumers and detected and recognised by the system. The symbols or characteristics can include any number or combination of brand, type, colour and style of clothing worn, whether the consumer is alone or with other people (and the type of people or pets the consumer is with), whether the consumer is carrying or using other objects (such as strollers or bags), whether the consumer is male or female, and the approximate age of the consumer (children, middle age or elderly). The above list of characteristics is just by way of example, the invention can also be used to recognise other features from which assumptions about consumers and their purchasing preferences can be made. Even the speed that they approach the camera can be taken into account.

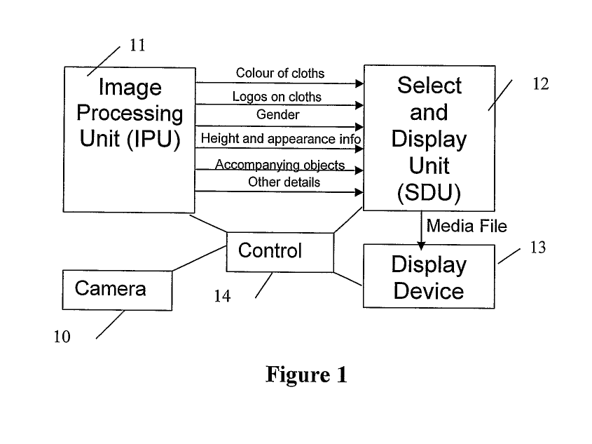

FIG. 1 shows the system schematically. The system comprises an image capture device 10, an image processing unit (IPU) 11, a select and display unit (SDU) 12 and a display device 13. Also shown is a central control unit 14.

The image capture device 10 is typically a camera. It may be a still camera or video camera, and may be a monochrome camera, a full colour camera or a camera that is sensitive to non-visible portions of the electromagnetic spectrum. The images captured may be a continuous video image feed, a set of grab frames or a still image. Multiple or stereo vision cameras may be used to provide means for generating three-dimensional images. Each single camera may have different objectives or filters for recording images at different wavelengths e.g. infrared or ultraviolet.

The images captured by the image capture device 10 are digitised. The means for digitising the images may be part of the image capture device 10 or may be part of IPU 11. The digitised images are then provided to processing means within the IPU.

The IPU 11 comprises a microprocessor, or a plurality of microprocessors, which run image processing algorithms on images received from the image capture device 10. The IPU may take the form of an ordinary personal computer (PC), an embedded computer or fully custom made processing Hardware. Images may be passed from the image capture device to the IPU via any suitable wired or wireless connection. Indeed, any of the connections shown in FIG. 1 may be a wired or wireless connection.

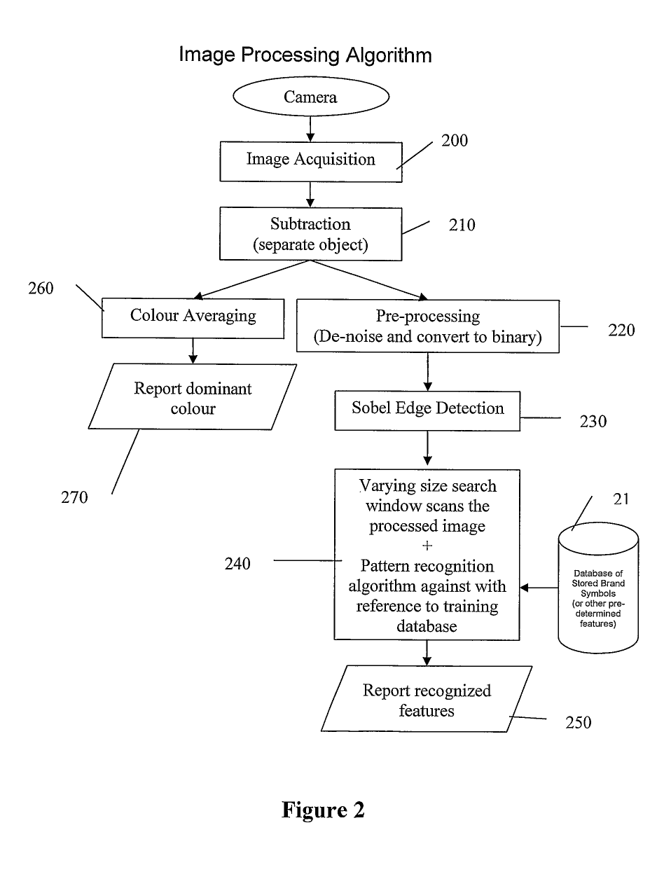

FIG. 2 illustrates an example of the steps performed by the IPU. In step 200, the image data is received from the image capture device. In step 210, a subtraction algorithm is used to separate consumers in the image from the background. Details of an algorithm suitable for this purpose can be found in R. Gonzalez and R. Woods, “Digital Image Processing”, Addison Wesley. The subtraction algorithm works because the system knows what the background looks like without any consumers in it. Subtraction of the known background from the captured image isolates the consumers that have entered the frame. After subtraction, the separated image proceeds through several further processing steps. In step 220, pre-processing is performed on the image. The pre-processing includes noise removal and conversion of the image to binary. [R. Gonzalez and R. Woods, “Digital Image Processing”, Addison Wesley] At step 230 edge detection is performed, using a Sobel edge detection algorithm. [R. Gonzalez and R. Woods, “Digital Image Processing”, Addison Wesley]. At this stage consumers in the image can be identified as separate entities. In order to recognise the symbols on the clothing, the edge detection technique is used to detect all the edges inside the binary image.

Following edge detection, in step 240, a varying size search window scans the processed image and a pattern recognition algorithm is used to detect the presence of symbols corresponding to those stored in database 21. Database 21 contains a reference set of images including brand symbols as well as other features such as outline shapes for pushchairs. A pattern recognition algorithm is used that compares the search window with the reference set of symbols' images. The detected symbols and their position within the image are recorded. The algorithm may include motion detector software that is capable of detecting differences between successive grab frames indicating movement. It will also be understood that the invention may make use of trained pattern recognition technologies such as Support Vector Machines (SVM). Trained SVMs require less computing power and permit the use of off-the-shelf personal computers while provides high accuracy. Using this technique, one or more visible symbols on the clothing are detected. The use of SVMs will also allow certainty ratings to be associated with each recognised symbol. See Cristianini, N. and Shawe-Taylor, J., An introduction to support vector machines: and other kernel-based learning methods, Cambridge University Press.

In addition, the IPU recognises the colour that is dominant in the upper part of each individual detected by the system. In step 260, the colour averaging over portions of the subtracted image takes place and the dominant colour is reported in step 270. This allows the system to guess the colour of the clothing worn by consumers in the image.

Each similarly coloured cluster may also be analyzed for texture. Regions or clusters of pixels with similar colour classifications may be determined and compared to identify and distinguish the texture of skin from clothing.

A report is generated at step 250, detailing each of the symbols detected in the image, and which consumer it are associated with. The report also includes details of the colour of clothing, as reported in step 270 as well as any other information extracted from the image. This report is sent to the SDU.

Examples of further information that may be extracted from the image are estimates of the type and style of clothing, the age category of consumers, the gender of consumers, the race of consumers, the relationship between consumers, the presence of a pushchair, skateboard, surfboard or bicycle and the speed of consumers. Algorithms for extracting this information are known in the art and further techniques, include template matching algorithms, Fourier analysis and advanced wavelet analysis may be used.

The SDU 12 receives a report from the IPU 11 and uses it to determine which advertising to broadcast. The report provides a list of symbols and characteristics that are associated with each person in the captured image. A certainty rating is assigned to each symbol or characteristic based on the outcome of the pattern matching algorithms used. The certainty ratings, together with a set of user defined rules determine which consumer in the captured image is targeted and which advertising media files are displayed.

The determination of which media to broadcast is performed quickly so that the image or other advertising is broadcast to the consumers whose image has been analysed before they have had time to move away. In other terminology, all of the processing performed by the IPU and the SDU is performed in real-time.

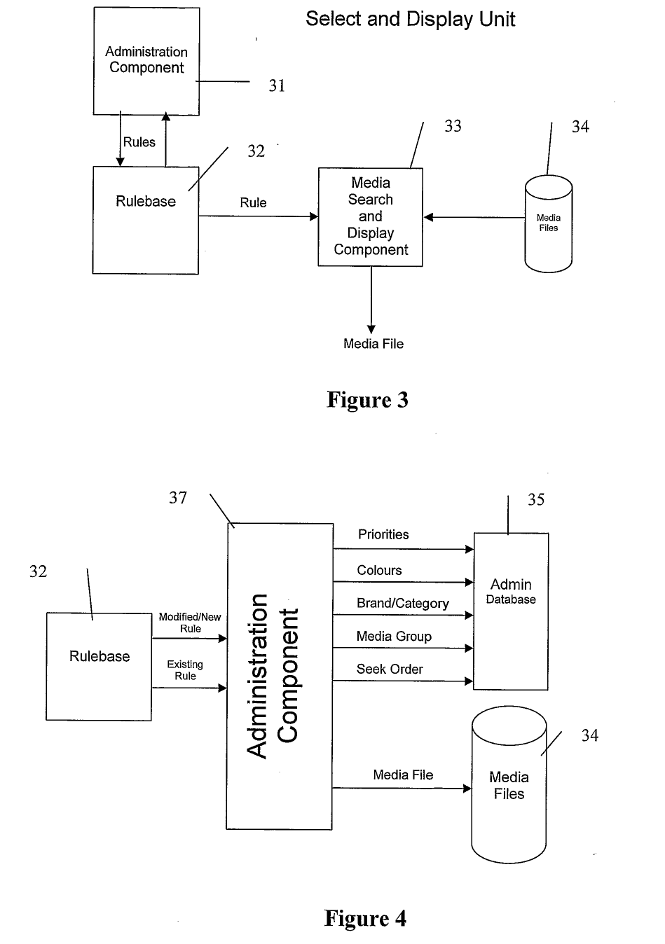

The SDU 12 comprises an administration component 31 that maintains and applies a set of rules in a rulebase 32, a media search and display component 33 and a database of media files 34. This is illustrated in FIG. 3. The media search and display component searches the rulebase for a match to the currently detected symbols and selects a media file from the database.

Rules are the basis of decision making in the SDU. The rules are generated and maintained by a system administrator, who can perform updating and maintenance tasks using the administration component. The administration component makes it possible to add rules or modify or delete existing rules. It allows the system administrator to define media groups, add media files, set priorities, define precedence and define seek order. As can be seen in FIG. 4, the administration component 31 maintains an administration database 35, a database of media files and a rulebase. Media files which are selected to play in response to the same symbols are grouped together in media groups.

The processor administration component has a user interface that allows the user to set up and edit rules which dictate when media files will be played. For example, a rule could state that a media file (or group of media files) should be played when the following circumstances arise:

a Nike symbol is detected

a Nike symbol on a blue shirt is detected

a Nike symbol on a blue shirt worn by a male is detected

a male is detected

a blue shirt is detected

a couple is detected

a parent and a child is detected

a Toyota symbol is detected

a Toyota Prius symbol is detected

a Toyota Prius symbol on a green car is detected

Each rule can be edited and the number of media files associated with each rule can be changed. Furthermore, the user can add weightings to each media file that increase or decrease the chance that that particular file will be chosen for display. The SDU also allows a significant amount of flexibility where multiple targets with a variety of associated symbols or characteristics are detected simultaneously. In such situations symbols or characteristics from one target must be selected in order to determine from which media group a media file is selected to play.

The first step is to choose which type of symbol or characteristic is to take priority over the others. This could be any number of symbols and characteristics recognised and detected by the invention, such as those described above, including t-shirt colour, male/female, or brand shown on the clothing worn by the user. For example, the user may choose brand as the type of symbol or characteristic which will take preference over other symbols and characteristics. This means that the brand worn on the consumer's clothing becomes the primary symbol or characteristic upon which the choice of advertisement is made.

The SDU 12 then allows the user to choose between two different methods of choosing which brand would be selected if multiple brands are detected and recognised in the same image. The first method chooses the symbol or characteristic which has been detected with the highest certainty.

The second method allows the user to manually give higher priority to certain symbols or characteristics. Using this method, where multiple symbols or characteristics have been detected and recognised, the invention will select the symbol or characteristic with the highest priority (as set manually by the user).

For both methods, once the type of symbol or characteristic with the highest certainty or priority (as set by the user) has been selected, then all the other symbols or characteristics associated with that particular target will continue to be considered when choosing which media file to play.

For example in an image the following targets with the associated symbols or characteristics may be detected in the same image:

| Target 1 | Target 2 | Target 3 |
|---|---|---|
| Nike (80% certainty) | Adidas (85% certainty) | Puma (90% certainty) |
| Red T-shirt | Blue T-shirt | White T-shirt |
| Male | Male | Female |
| Alone | With child | With male |

In this example the user has made brand the primary symbol or characteristic (as opposed to shirt colour, male/female, or who the consumer is with), and of the brands, Nike has been set with the highest priority. However, in this example, Puma has been detected and recognised with the highest certainty.

If the user instructed the system to use the priority method of choosing between multiple brands in the same image, then the consumer with the Nike symbol would be targeted with an advertisement. The Nike symbol and all the other symbols or characteristics associated with the target (Red t-shirt, male, alone) would be used to choose a media file to play.

However if the user instructed the system to use the certainty method of choosing between multiple brands in the same image then the consumer with the Puma symbol would be targeted with an advertisement. The Puma symbol and all the other symbols or characteristics associated with the target (white t-shirt, female, with male) would be used to choose a media file to play.

The output of the SDU 12 is a media file which is displayed on the display device 13 using an appropriate media player. The media file can be, for example, a static image, a movie, text, sound or flash file.

More than one media file or group can be associated with a particular symbol or characteristic and in such cases a media file can be chosen at random from those particular media groups. Furthermore, as stated above, the user can add weightings to each media file which can increase the chance that a particular file will be chosen to display.

A system in accordance with the present invention may be used in a number of settings. One such setting is in a shopping mall, a supermarket or a retail store. A system according to the present invention may also be used in outdoor locations such as streets and stadiums, as well as other public places such as airports and railway stations.

Advertisers have a variety of ways in which to use the system. Options include a simple static advertisement of a product expected to appeal to the particular targeted consumer (or a television commercial of the product could be played). The screen could show one of several different advertisements for the same product (based on which advertisement would be most likely to appeal to the particular person who is being targeted). Alternatively, the screen could specifically direct the message at the consumer based on what the consumer is wearing.

For example, the advertisement might be tailored to the person wearing the “white Adidas cap” or the “blue Nike shirt”. A person wearing a Golfpunk t-shirt could be told that “the Formosa golf course is having a half price day next Wednesday”. Someone with a Billabong t-shirt could be told that “New season's styles have just arrived” at the nearby surf shop. Alternatively, the advertiser may choose to display the current swell forecast with the message “Why aren't you surfing? Billabong”. A static advertisement of specials on baby products could be shown when someone detected with a baby buggy is targeted.

In addition, advertisements can be specifically tailored to men, women, couples, parents with children and groups of males and females.

The invention could also be used in outdoor locations to target drivers of cars. For example, a unit can be set up so as to focus on cars at a set of traffic lights, with the screen facing those cars. The camera captures the images of the cars at the set of lights and the processor analyses the images, searching for car brand and model symbols and car colour.

Advertisers then have a variety of options. These include:
targeting a specific driver (the screen could display a personalised message designed to grab the driver's attention—such as “Hey you in the red Ford Mondeo! You look like you need a break—get 4 nights in the Gold Coast for $299);
targeting the type of driver (drivers of Toyota Prius' could be targeted with green focused products while V8 drivers could be told they could “Take the whole family to Pukekoe for only $50”); or
targeting specific brands (Ford could run a campaign targeting Holden drivers, or alternatively build brand loyalty with an offering to current Ford drivers).

Also, personalised number plates can be recognized (due to their non-standard use of number and letter combinations). These can be scanned against databases of names to refer to the car driver by name. For example, the processor would recognize the plates “EMMAS1”, “4EMMA” or “EMMAS”, and display messages incorporating the name Emma.

The present invention is compatible with a number of business models. Revenue from advertisers can be generated on a simple fee per display basis, or a more complex model can be used. In one scheme, advertisers pay fees in order to have their media files prioritized. They also pay fees in order to have particular symbols or characteristics prioritized. For example, a sportswear manufacturer may pay a premium in order to increase the chance that whenever a Nike or Adidas trademark is detected it becomes the symbol that determines which media file is selected. They can also pay a premium to increase the likelihood that their media files are selected from the group of media files associated with Nike or Adidas trademarks. In this way advertisers are made to compete with each other, in order to maximise revenue. Other business models include exclusivity in respect of detection of a particular symbol or characteristic.

The present invention offers advertisers the chance to target individual consumers based on real-time extraction of information from images. The targeting is individual rather than based on statistical analysis of large groups of people or the passage of people over time. It is highly responsive to changes in the consumers present. Information relating to consumers can be stored and relayed back to advertisers so that they can analyse who their advertising has reached, how many people have viewed it and for how long the advertising was displayed. This allows advertisers to refine their advertising strategy to get the best possible return on investment.

The invention also has many other commercial uses, such as evaluating the amount of time that a brand is shown on television during a sports event or providing instant personalised feedback or advertising during sports events where competitors have entry numbers and can be personally identified (such as marathons).

It is to be understood that the scope of the invention is not limited to the described embodiments and therefore that numerous variations and modifications may be made to these embodiments without departing from the scope of the invention as set out in this specification.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

1. A system for providing advertising media to consumers comprising:
image capture means;
an image processing unit connected to the image capture means, in use, the image processing unit executing one or more pattern recognition algorithms on an image received from the image capture means to extract information from the image relating to consumers in the image, and compiling a list of attributes associated with an individual consumer based on the extracted information;
an advertising media database;
an advertising selection unit connected to the image processing unit and the advertising media database, in use the advertising selection unit selecting advertising media from the advertising media database based on the list of attributes; and
an advertising delivery unit connected to the advertising selection unit for delivering advertising media selected by the advertising selection unit.

2. A system for providing advertising media to consumers as claimed in claim 1 wherein, when the image includes more than one consumer, the image processing unit compiles a list of attributes for each individual consumer in the image.

3. A system for providing advertising media to consumers as claimed in claim 1 wherein, the image processing unit compiles lists of attributes for only some of the individual consumers.

4. A system for providing advertising media to consumers as claimed in claim 1 wherein, the image capture means includes a camera.

5. A system for providing advertising media to consumers as claimed in claim 4 wherein, the camera is a digital camera.

6. A system for providing advertising media to consumers as claimed in claim 4 wherein, the image capture means includes further cameras and sensors.

7. A system for providing advertising media to consumers as claimed in claim 1 wherein, the image processing unit comprises one or more microprocessors.

8. A system for providing advertising media to consumers as claimed in claim 1 wherein, the advertising selection unit comprises one or more microprocessors.

9. A system for providing advertising media to consumers as claimed in claim 1 wherein, the image processing unit and the advertising selection unit are integrated in a single hardware device.

10. A system for providing advertising media to consumers as claimed in claim 1 wherein, the image processing unit and the advertising selection unit are distributed over two or more hardware devices.

11. A system for providing advertising media to consumers as claimed in claim 1 wherein, the advertising delivery unit comprises a display screen.

12. A system for providing advertising media to consumers as claimed in claim 1 wherein, the list of attributes compiled by the image processing unit relates to clothing worn by the consumer.

13. A system for providing advertising media to consumers as claimed in claim 1 wherein, the list of attributes includes at least one of whether the consumer is alone or in a group, whether the consumers in the image includes at least one a child, an estimation of the consumer's age, race, gender, and attire type (i.e., formal or casual).

14. A system for providing advertising media to consumers as claimed in claim 1 wherein, the image capture means and the advertising delivery unit are located proximate to one another.

15. A system for providing advertising media to consumers as claimed in claim 1 wherein, the image capture means and the advertising delivery unit are installed in a public place.

16. A system for providing advertising media to consumers as claimed in claim 1 wherein, the advertising delivery unit includes at least one of: a loud speaker, means to emit a scent or means to deliver promotional goods.

17. A system for providing advertising media to consumers as claimed in claim 1 wherein, the advertising selection unit is configured to select advertising media based on the list of attributes and rules stored within the advertising selection unit.

18. A system for providing advertising media to consumers as claimed in claim 1 wherein, the system further includes a control unit connected to the advertising selection unit that allows the rules to be amended by a user.

19. A system for providing advertising media to consumers as claimed in claim 1 wherein, the image processing unit executes the one or more pattern recognition algorithms at set time intervals.

20. A system for providing advertising media to consumers as claimed in claim 1 wherein, the image processing unit does not execute the one or more pattern recognition algorithms when advertising is being delivered by the advertising delivery unit.

21. A method for providing targeted advertising to consumers comprising the steps of:
capturing an image of one or more consumers;
executing one or more pattern recognition algorithms on the image to extract information from the image relating to consumers in the image, and compiling a list of attributes associated with an individual consumer based on the extracted information;
selecting advertising media from a store of advertising media files based on the list of attributes; and
delivering advertising media to the consumers selected by the advertising selection unit.

22. A method for providing targeted advertising to consumers as claimed in claim 21 wherein, the method steps are performed in real-time so as to deliver targeted advertising to the consumer soon after the image has been captured.

23. A method for providing targeted advertising to consumers as claimed in claim 21 further includes the step of assigning a certainty ranking to each attribute in the list of attributes.

24. A method for providing targeted advertising to consumers as claimed in claim 21 wherein, the step of selecting advertising media based on the list of attributes further includes disregarding all attributes with a certainty ranking below a user set threshold.

25. A method for providing targeted advertising to consumers as claimed in claim 21 wherein, the step of selecting advertising media includes applying a set of rules to the list of attributes and the media files to determine which advertising media to deliver.

26. A method for providing targeted advertising to consumers as claimed in claim 25 further including the step of editing the rules.

27. A method for providing targeted advertising to consumers as claimed in claim 21 further including the step of assigning weighting values to each advertising media file.

28. A method for providing targeted advertising to consumers as claimed in claim 21 wherein, the step of editing the rules comprises prioritising a type of symbol or characteristic as the basis for selection of an advertising media file.

29. A system for providing advertising media to consumers comprises:
image capture means;
an image processing unit connected to the image capture means, in use, the image processing executing one or more pattern recognition algorithms on an image received from the image capture means to extract information from the image relating to non-physiological attributes of the consumers in the image;
an advertising media database;
an advertising selection unit connected to the image processing unit and the advertising media database, in use, the advertising selection unit selecting advertising media from the advertising media database based on the extracted information; and
an advertising delivery unit connected to the advertising selection unit for delivering advertising media selected by the advertising selection unit.

30-31. (canceled)
